(19) United States
(12) Patent Application Publication
(10) Pub. No.: US 2017/0001381 A1
(43) Pub. Date: Jan. 5, 2017

(54) SHAPING SYSTEM AND SHAPING METHOD

(71) Applicant: CANON KABUSHIKI KAISHA, Tokyo (JP)

(72) Inventors: Noriyuki Suzuki, Tokyo (JP); Ikuo Sobue, Kawasaki-shi (JP); Shigeki Sakurai, Yokohama-shi (JP)

(21) Appl. No.: 15/193,728

(22) Filed: Jun. 27, 2016

(30) Foreign Application Priority Data
Jun. 30, 2015 (JP) 2015-131763

(51) Int. Cl. B29C 67/00; G03G 15/00

(52) U.S. Cl. CPC B29C 67/0088; B29C 67/0074; G03G 15/00

(57) ABSTRACT

A shaping system of a three-dimensional object includes a control unit which performs an operation of supplying data of a calibration marker to the material layer forming unit and stacking a material layer formed based on the data of the calibration marker on the stage, and an operation of supplying, to the material layer forming unit, data for arranging the shaping material in an entire area of the shaping area excluding an arrangement area of the calibration marker after the material layer formed based on the data of the calibration marker and stacking, on the stage, a material layer formed based on the data for arranging the shaping material in the entire area of the shaping area excluding the arrangement area of the calibration marker.

### BACKGROUND OF THE INVENTION

Field of the Invention

The present invention relates to a shaping system and a shaping method.

Description of the Related Art

Shaping systems which form a three-dimensional shaping object by stacking a large number of layers are drawing attention. Stack shaping technology of this type is referred to as additive manufacturing (AM), three-dimensional printing, rapid prototyping, and the like. Various shaping methods are proposed to implement the stack shaping technology. Japanese Patent Application Laid-open No. H10-224581 and Japanese Patent Application Laid-open No. 2003-053846 disclose shaping methods utilizing an electrophotographic process while US Patent Application Publication No. 2009/0060386 (Specification) discloses a laser sintering method.

### SUMMARY OF THE INVENTION

In a shaping system, a shape accuracy of a sectional image of each layer (image formation accuracy) and a positional accuracy when stacking the respective layers (stacking accuracy) may have a significant impact on quality of a final shaping object. In particular, this becomes a major issue with stacking methods involving independently forming images of respective layers and sequentially stacking the images as is the case of the apparatuses according to Japanese Patent Application Laid-open No. H10-224581 and Japanese Patent Application Laid-open No. 2003-053846. However, with the apparatuses disclosed in Japanese Patent Application Laid-open No. H10-224581 and Japanese Patent Application Laid-open No. 2003-053846, distortion of images and variation in image positions are not addressed and image formation accuracy and stacking accuracy are not guaranteed.

US Patent Application Publication No. 2009/0060386 (Specification) discloses a position calibration method for an apparatus adopting a laser sintering method, in which a calibration plate is scanned prior to start of shaping to determine a center reference of an image. However, this method simply adjusts a drawing position of the image to a center of a stage and does not correct distortion of the image itself. In addition, this method cannot be applied to stacking methods involving independently forming images of respective layers and sequentially stacking the images as described in Japanese Patent Application Laid-open No. H10-224581 and Japanese Patent Application Laid-open No. 2003-053846.

As a calibration method, a method is conceivable in which, prior to forming a shaping object, a reference marker is formed at a prescribed position on a stage, positional information thereof is read by a sensor, and distortion of a subsequently formed image is corrected based on the positional information. However, since stacking reference markers results in a reference marker portion rising at a prescribed position on the stage, there is a concern that a shaping object cannot be formed using the stage in its entirety including the prescribed position.

Although a configuration may be adopted in which a reference marker is removed from the stage after correcting image distortion, removing a marker by a manual operation reduces convenience and providing removing means that automatically scrapes off or washes off the marker complicates the apparatus configuration. While adopting a configuration in which a position of formation of a reference marker is set in an area not used during subsequently formation of a shaping object and the reference marker is left as it is after image distortion correction eliminates the need to remove the marker, this also results in reducing an effective shaping area.

The present invention has been made in consideration of the circumstances described above and an object thereof is to provide, in a shaping system adopting a method involving independently forming images of respective layers and sequentially stacking the images on a stage to obtain a three-dimensional shaping object, a technique for improving quality and accuracy of a shaping object while effectively utilizing a shaping area on the stage.

The present invention in its first aspect provides a shaping system of a three-dimensional object, comprising: a material layer forming unit which arranges a shaping material based on supplied data to form a material layer; a shaping unit which stacks the material layer on a shaping area of a stage; and a control unit which controls the material layer forming unit and the shaping unit, wherein the control unit performs an operation of supplying data of a calibration marker to the material layer forming unit and stacking a material layer formed based on the data of the calibration marker on the stage, and an operation of supplying, to the material layer forming unit, data for arranging the shaping material in an entire area of the shaping area excluding an arrangement area of the calibration marker after the material layer formed based on the data of the calibration marker and stacking, on the stage, a material layer formed based on the data for arranging the shaping material in the entire area of the shaping area excluding the arrangement area of the calibration marker.

The present invention in its second aspect provides a shaping method of fabricating a three-dimensional object by sequentially stacking a material layer, in which a shaping material is arranged based on data, in a shaping area of a stage, the shaping method comprising the steps of: forming a material layer based on data of a calibration marker and stacking the material layer in the shaping area; and arranging the shaping material in the entire shaping area excluding a area in which the material layer formed based on the data of the calibration marker is arranged.

According to the present invention, in a shaping system adopting a method involving independently forming images of respective layers and sequentially stacking the images on a stage to obtain a three-dimensional shaping object, quality and accuracy of a shaping object while effectively utilizing a shaping area on the stage can be improved.

Further features of the present invention will become apparent from the following description of exemplary embodiments with reference to the attached drawings.

### BRIEF DESCRIPTION OF THE DRAWINGS

FIG. 1 is a diagram schematically showing a configuration of a shaping system according to an embodiment;

FIG. 2 is a circuit block diagram of a shaping controller;

FIGS. 3A to 3C are diagrams illustrating calibration markers and image distortion;

FIG. 4 is a functional block diagram related to calibration and registration;

FIGS. 5A and 5B are flow charts representing calibration and image distortion correction;

FIGS. 6A to 6C are conceptual diagrams of image distortion correction;

FIG. 7 is a conceptual diagram of detection of a registration transfer marker;

FIG. 8 is a diagram showing a configuration of a shaping system including two cartridges;

FIG. 9 is a diagram depicting calibration markers;

FIG. 10 is a flow chart showing a procedure of a stacking operation;

FIGS. 11A to 11D are schematic sectional views showing a shaping process on the stage.

### DESCRIPTION OF THE EMBODIMENTS

A mode for implementing the present invention will now be exemplarily described with reference to the drawings. It is to be understood that procedures, control parameters, target values, and the like of various types of control including dimensions, materials, shapes, relative arrangements, and the like of respective members described in the following embodiment are not intended to limit the scope of the present invention to the embodiment described below unless specifically stated otherwise.

### Embodiment

### Configuration of Shaping System

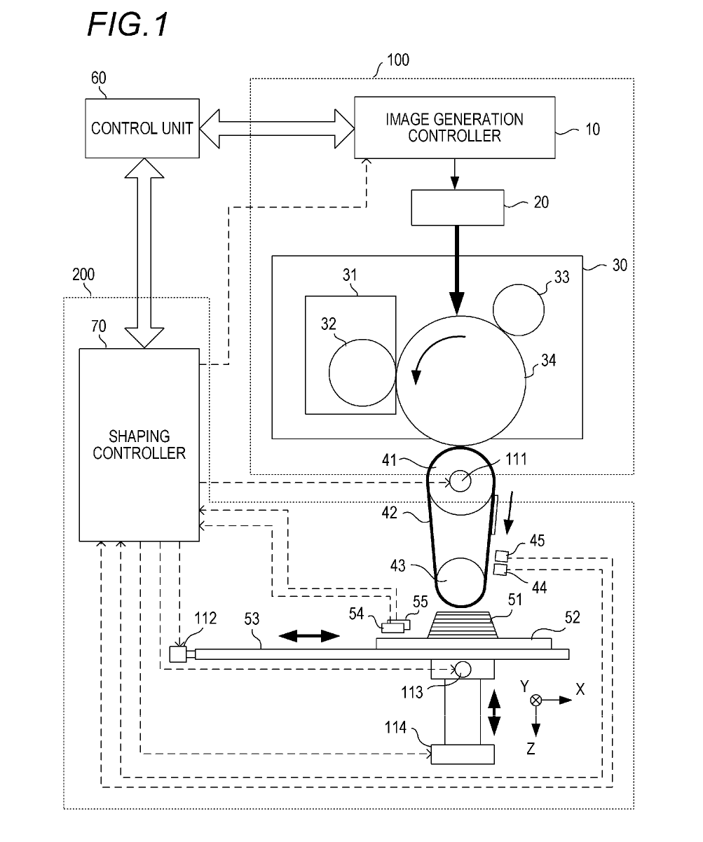

A configuration of a shaping system according to an embodiment of the present invention will be described with reference to FIG. 1. FIG. 1 is a diagram schematically showing a configuration of a shaping system according to an embodiment.

A shaping system is a system which creates a three-dimensional (stereoscopic) shaping object by stacking a large number of thin films. This system is also referred to as an additive manufacturing (AM) system, 3D printer, rapid prototyping (RP) system, and the like.

The shaping system according to the present embodiment roughly includes a material layer forming unit 100, a shaping unit 200, and a control unit 60. The material layer forming unit 100 is a component which forms a material layer made of a shaping material based on slice data of each layer.

The material layer forming unit 100 is constituted by an image generation controller, a laser scanner (an exposing apparatus) 20, a process cartridge 30, a transfer roller 41, and the like. The shaping unit 200 is a component which forms a three-dimensional shaping object having a three-dimensional structure by sequentially stacking and fastening the material layer formed by the material layer forming unit 100. The shaping unit 200 is constituted by a shaping controller, a transfer body 42, a heater roller 43, a stage 52, a stage guide 53, a plurality of motors 111 to 114, a plurality of sensors 44, 45, 54, and 55, and the like. The control unit 60 is a component which performs a process of generating slice data (sectional data) of a plurality of layers from data of a three-dimensional shape of a shaping target object, controls various parts of a three-dimensional shaping apparatus such as the material layer forming unit 100, and the like.

(Control Unit)

The control unit 60 has a function of generating slice data for shaping from three-dimensional shape data of a shaping target object, a function of outputting slice data of each layer to the image generation controller 10 and a function of managing a shaping step and the like. The control unit 60 can be constructed by, for example, mounting a program having these functions to a personal computer or an embedded computer. As data of a three-dimensional shape, data created by a three-dimensional CAD, a three-dimensional modeler, a three-dimensional scanner, and the like can be used. While the data of a three-dimensional model may have any format, for example, polygon data of stereolithography (STL) can be favorably used. In addition, as a format of slice data, for example, multi-valued image data (in which each value represents a type of material) or multi-plane image data (in which each plane corresponds to a type of material) can be used.

(Material Layer Forming Section)

The image generation controller 10 has a function of controlling a material layer forming process by the material layer forming unit 100 based on slice data which are input from the control unit 60, a control signal which is input from the shaping controller 70, and the like. Specifically, the image generation controller 10 performs a resolution conversion process or a decoding process of slice data, controls an image read position and an image read timing by the laser scanner 20, and the like. In addition, the image generation controller 10 may have functions similar to those of a printer controller built into a general laser printer (2D printer).

The material layer forming unit 100 is, for example, a unit which forms an image (a material layer) corresponding to one layer made of a shaping material using an electrophotographic process. An electrophotographic process refers to a method of forming a desired material layer by a series of processes including charging a photoreceptor, forming a latent image by exposure, and causing developer particles to adhere to the latent image to form an image. Although a shaping system uses particles of a shaping material as a developer in place of a toner, a basic principle of an electrophotographic process is approximately the same as that of a 2D printer. While an example in which the material layer forming unit 100 uses an electrophotographic process will be described below, the present invention can also be applied to cases where other methods such as an inkjet process are used.

A photosensitive drum 34 is an image bearing member including a photoreceptor layer of an organic photoreceptor, an amorphous silicon photoreceptor, or the like. A primary charging roller 33 is a charging apparatus for uniformly charging the photoreceptor layer of the photosensitive drum 34. The laser scanner 20 is an exposing apparatus which scans an outer surface of the photosensitive drum 34 with laser light and draws a latent image in accordance with an image signal supplied by the image generation controller 10. A shaping material supplying section 31 is an apparatus which stores and supplies a shaping material as a developer. A developing roller 32 is a developing apparatus which supplies the shaping material to an electrostatic latent image on the photosensitive drum 34. The transfer roller 41 is a transfer apparatus which transfers a shaping material image formed on the photosensitive drum 34 to a transfer body 42. Although not illustrated, a cleaning apparatus for cleaning the surface of the photosensitive drum 34 may be provided on a downstream side of a transfer nip between the photosensitive drum 34 and the transfer roller 41. In the present embodiment, the photosensitive drum 34, the primary charging roller 33, the shaping material supplying section 31, and the developing roller 32 are integrated as the process cartridge 30 and configured so as to be attachable and detachable with respect to a system main body of the shaping system and to be readily replaceable.

As the shaping material, various materials can be selected in accordance with an application, a function, a purpose, and the like of a shaping object to be created. In the present specification, a material to constitute a shaping object main body will be referred to as a “build material” and a portion constituted by the build material will be referred to as a “build body”. A structure for supporting a build body midway through shaping in a shaping operation will be referred to as a “support body” (for example, a pillar that supports an overhanging portion from below) and a material that constitutes the support body will be referred to as a “support material”. Moreover, when a distinction need not be made between the materials, the term “shaping material” will be simply used. As the build material, for example, a thermoplastic resin such as polyethylene (PE), polypropylene (PP), ABS, and polystyrene (PS) can be used. In addition, as the support material, a material having thermoplastic and water-soluble properties can be favorably used to enable the support material to be readily removed from a shaping object main body. Examples of a material for the support body include carbohydrates, polylactic acid (PLA), polyvinyl alcohol (PVA), and polyethylene glycol (PEG).

(Shaping Unit)

The shaping controller 70 has a function of performing mechatronic control of the shaping apparatus based on a control signal which are input from the control unit 60. A drive system includes a transfer roller motor 111 that rotates the transfer roller 41, and a stage X-drive motor 112, a stage Y-drive motor 113, and a stage Z-drive motor 114 which performs three axis movement of the stage 52. A sensing system includes a material front end detection sensor 44 used in online registration, and a material front end detection sensor 45, a material left front end sensor 54, and a material right front end sensor 55 which are used in offline calibration. The roles performed by these sensors and details of online registration and offline calibration will be provided later.

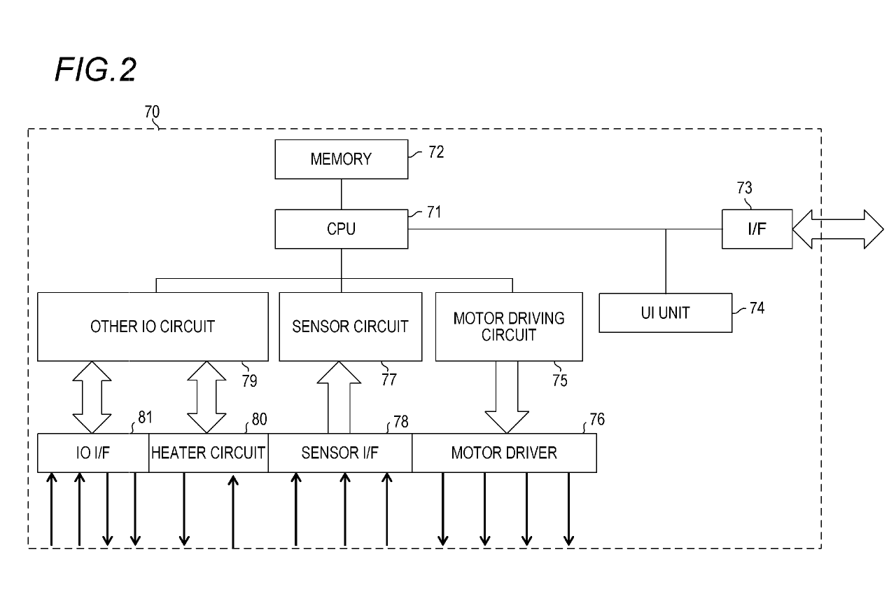

FIG. 2 shows an example of a circuit block of the shaping controller 70. The shaping controller 70 includes a CPU 71, a memory 72, an interface 73, a UI section 74, a motor driving circuit 75, a motor driver 76, a sensor circuit 77, a sensor interface 78, other input/output (IO) circuit 79, a heater circuit 80, and an IO interface 81. The transfer roller motor 111, the stage X-drive motor 112, the stage Y-drive motor 113, and the stage Z-drive motor 114 are connected to the motor driver 76. The material front end detection sensor 44, the material front end detection sensor 45, the material left front end sensor 54, and the material right front end sensor 55 are connected to the sensor interface 78. A heater and a thermocouple inside the heater roller 43 are connected to the heater circuit 80. Although not illustrated, an open cover detection switch of a three-dimensional shaping apparatus, a home position sensor of the stage 52, and the like are connected to the IO interface 81.

The transfer body 42 is a conveying member which bears a material layer formed by the material layer (shaping material image) forming section 100 and which conveys the material layer to the stage 52 (a stack nip). The transfer body 42 is constituted by an endless belt made of a resin, polyimide, or the like. The heater roller 43 is a heating and stacking apparatus which has a built-in heater and which melts a material layer on the transfer body 42 and stacks (fastens) the material layer on a shaping object on the stage 52. The stage 52 is a member which holds a shaping object during shaping and can be moved by the stage guide 53 in directions of the three axes of X, Y, and Z.

(Operation of Shaping System)

Next, a basic operation by the shaping system for creating a shaping object will be described.

The control unit 60 generates slice data to be used in shaping with the slice data generating section. For example, three-dimensional shape data of a shaping target object is sliced at a prescribed pitch (for example, at a thickness of several microns to slightly more than 10 microns) to generate a slice image of each layer. Subsequently, an image of a registration marker (to be described in detail later) is added to the slice image of each layer to generate slice data of each layer. Generation of the slice image of each layer need not necessarily be performed by the control unit 60. A slice image generated outside of the control unit 60 is acquired and the slice data of each layer may be generated by adding a slice image of a registration marker to the slice image generated outside of the control unit 60. In other words, the slice data generating section need not be dedicated to the shaping system and an external device connected via the Internet may be used as long as the external device is capable of generating slice data and sending the slice data to the shaping system. Slice data is sequentially input to the image generation controller 10 beginning with the slice data corresponding to a lowermost layer. The image generation controller 10 controls laser light emission and scanning by the laser scanner 20 in accordance with input slice data.

In the material layer forming unit 100, a surface of the photosensitive drum 34 is uniformly charged by the primary charging roller 33. When the surface of the photosensitive drum 34 is exposed by laser light from the laser scanner 20, an exposed portion thereof is neutralized and a latent image is generated. Shaping material charged by a developing bias is supplied to the neutralized portion by the developing roller 32 and the shaping material is arranged on the surface of the photosensitive drum 34 in accordance with the latent image. This image is transferred onto the transfer body 42 by the transfer roller 41. Hereinafter, a layer made of the shaping material transferred to the transfer body 42 will be referred to as a material layer. When a plurality of types of shaping materials are used, the material layer forming unit 100 is provided with process cartridges in a number corresponding to the types of materials. In accordance with slice data, a latent image for each material is generated and the shaping material is arranged at each process cartridge, and a material layer corresponding to one slice is formed by combining the latent images and the shaping materials on the transfer body 42.

The transfer body 42 rotates while bearing the material layer and conveys the material layer to a stack position. Meanwhile, the shaping controller 70 controls the stage 52 so that the stage 52 (or the shaping object on the stage 52) enters the stack position at a same timing and at a same speed as the material layer. In addition, by applying heat with the heater roller 43 while synchronously moving the stage 52 and the transfer body 42, the material layer is thermally welded onto the stage 52 (or onto an upper surface of the shaping object on the stage 52). Each time a material layer is stacked, the shaping controller 70 lowers the stage 52 in a Z direction by a thickness of one layer and stands by to stack a next layer.

By repetitively performing the material layer forming step of forming a material layer and the shaping step (the shaping operation) of stacking the material layer described above for a plurality of times corresponding to the number of pieces of slice data, the shaping object is formed on the stage 52.

Moreover, in the present specification, an object to be created by the shaping system (in other words, an object represented by three-dimensional shape data supplied to the shaping system) will be referred to as a “shaping target object” and an object created by (output from) the shaping system will be referred to as a “shaping object”. In addition, when the shaping object includes a support body, the term “build body” will be used when particularly referring to a portion excluding the support body. Furthermore, data including data corresponding to one slice that is obtained by slicing data of a three-dimensional shape of a shaping target object will be referred to “slice data” corresponding to one layer. An image corresponding to one layer made of the shaping material which is formed by the material layer forming unit based on slice data will be referred to as a “material layer”.

(Problems in Shaping)

With a shaping system of a type (stacking type) in which a large number of material layers are stacked to form a shaping object as in the present embodiment, two factors determine a quality of a final shaping object: shape accuracy of the material layers and positional accuracy during stacking. For example, distortion may occur in a material layer due to scanning accuracy of exposure, dimensional accuracy of a photosensitive drum or a transfer roller, and the like. Accumulation of such image distortion has a non-negligible effect on dimensions and a shape of the shaping object. This issue can be considered specific to shaping systems that create a shaping object by stacking material layers when the number of material layers consists of three or more digits.

In consideration thereof, in the present embodiment, in order to secure shape accuracy of a material layer of each layer, prior to forming a shaping object, image distortion occurring in the material layer forming unit 100 is measured (this is referred to as offline calibration) and image distortion correction is performed on slice data of each layer when forming a material layer. Although a calibration marker is formed on a stage at this point in order to correct image distortion, a feature of the present embodiment is that an entire shaping area including the marker can be used as an effective shaping area when forming a shaping object.

In addition, in the present embodiment, in order to secure positional accuracy during stacking, a position of the material layer of each layer on a transfer body is measured and positioning between the material layer and the shaping object on the stage is performed during stacking (this is referred to as online registration). This is a process which addresses an issue in that positional variation which exists when stacking the material layer of each layer on a shaping object causes irregularities to form on a side surface of the obtained shaping object and prevents a smooth surface from being obtained.

Hereinafter, offline calibration, image distortion correction, and online registration will be described in detail.

(Offline Calibration)

Offline calibration that is performed before generating a shaping object will be described. In offline calibration, a calibration marker is formed on the stage 52 and information related to image distortion (image distortion information) is acquired based on a deviation of a position of the marker in a similar procedure to the material layer formation and shaping described earlier. Moreover, offline calibration is not limited to before generation of a shaping object and can also be performed between stacking of the material layers.

In the following description, image data for a calibration marker supplied to the image generation controller 10 will be referred to as “calibration marker data”. Calibration marker data is stored in, for example, a memory of the control unit 60 and read when performing offline calibration. In addition, an image made of shaping material formed based on calibration marker data will be referred to as a “calibration marker” or simply a “marker”. Furthermore, a marker transferred to the transfer body 42 from the photosensitive drum 34 (in other words, a marker on the transfer body 42) will be referred to as a “calibration transfer marker” and a marker transferred onto the stage 52 will be referred to as a “calibration stack marker”. The name of a marker is changed from one location to another because locations of the marker are favorably distinguished from one another for the same of brevity due to the fact that image distortion may change as the marker is transferred, the marker is detected using a different sensor at each location, and the like. Moreover, in a context where locations need not be particularly distinguished, the term “calibration marker” or “marker” will be used.

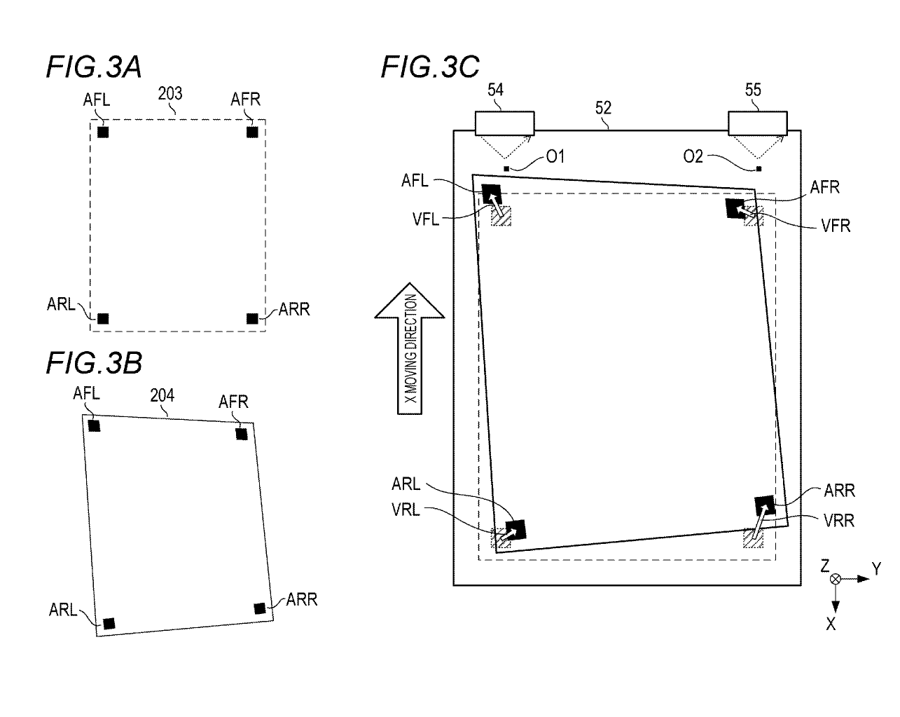

FIG. 3A shows an example of a calibration marker (in a state where there is no image distortion) used in the present embodiment. A square area 203 indicated by a dotted line represents a range (an image area) in which a 200 mm (horizontal) by 300 mm (vertical) image can be formed. A size of the image area 203 is equal to a size of a shaping area (a maximum area in which shaping can be performed) on the stage 52. A front left end calibration marker AFL, a front right end calibration marker AFR, a rear left end calibration marker ARL, and a rear right end calibration marker ARR are placed at four corners of the image area 203. The markers AFL, AFR, ARL, and ARR are 5 mm by 5 mm square images and are generated at centers of 10 mm by 10 mm square areas at the four corners of the image area 203.

FIG. 3B shows an example of a calibration stack marker transferred onto the stage 52. A situation is shown where the image area 204, positions of the markers AFL, AFR, ARL, and ARR at the four corners, and relative positions among the markers have changed due to image distortion occurring during material layer formation and/or shaping.

FIG. 3C is a schematic diagram showing configurations of a stage, a calibration stack marker, and a sensor. An origin O1 and an origin O2 to be used as detection references by the sensor are described on the stage 52. Since the origins O1 and O2 are to be used as dimensional references, high positional accuracy is required. Therefore, the origins O1 and O2 are desirably created by high-accuracy printing such as laser marking or by boring using a high-accuracy NC process. Since detection accuracy of the sensor is also affected, in the case of an optical sensor such as that used in the present embodiment, a printing method or a processing method that produces maximum contrast between an origin and its periphery is desirable. In this case, the origins O1 and O2 are created by laser marking.

Above the stage 52, the material left front end sensor 54 is arranged at a Y position corresponding to the origin O1 and the material right front end sensor 55 is arranged at a Y position corresponding to the origin O2. The material left front end sensor 54 is a sensor for detecting positions of the front left end calibration marker AFL and the rear left end calibration marker ARL. The material right front end sensor 55 is a sensor for detecting positions of the front right end calibration marker AFR and the rear right end calibration marker ARR. Vectors VFL, VFR, VRL, and VRR shown in FIG. 3C respectively represent displacement (a deformation vector) of the markers AFL, AFR, ARL, and ARR with respect to positions of AFL, AFR, ARL, and ARR in a state with no image distortion. The offline calibration according to the present embodiment is a process of actually forming calibration markers on the stage 52 and actually measuring the deformation vectors VFL, VFR, VRL, and VRR which are created due to material layer formation and shaping.

Normally, deformation vectors of the markers at the four corners are not vectors in a same direction. This is because a direction and a magnitude of displacement differ for each position in the shaping area due to distortion of the transfer body 42, a deviation in alignment of each roller shaft, and the like. Therefore, as a calibration marker, a deformation vector need only be acquired for a plurality of points in the shaping area. For example, at least two or more markers are arranged at positions separated from each other in the shaping area on the stage and a deformation vector at each position is detected (measured) and, desirably, markers are arranged at the four corners of a rectangular shaping area as in the present embodiment. A calibration marker constituted by a plurality of markers are not limited, and a frame-like material layer connecting AFL, AFR, ARL, and ARR may be formed as a calibration marker and deformation vectors may be measured at corners of the frame. Accordingly, a displacement occurring at each marker position in the shaping area can be obtained. Moreover, since the use of a hard belt member as the transfer body 42 results in an occurrence of a relatively linear displacement at each position in the shaping area, a deformation vector at positions other than the markers at the four corners can be obtained by linear interpolation of deformation vectors obtained from the markers at the four corners. When deflection of the transfer body 42 is partially periodical or discontinuous, the number of calibration markers may be increased. For example, a plurality of markers are desirably arranged along four sides of the shaping area.

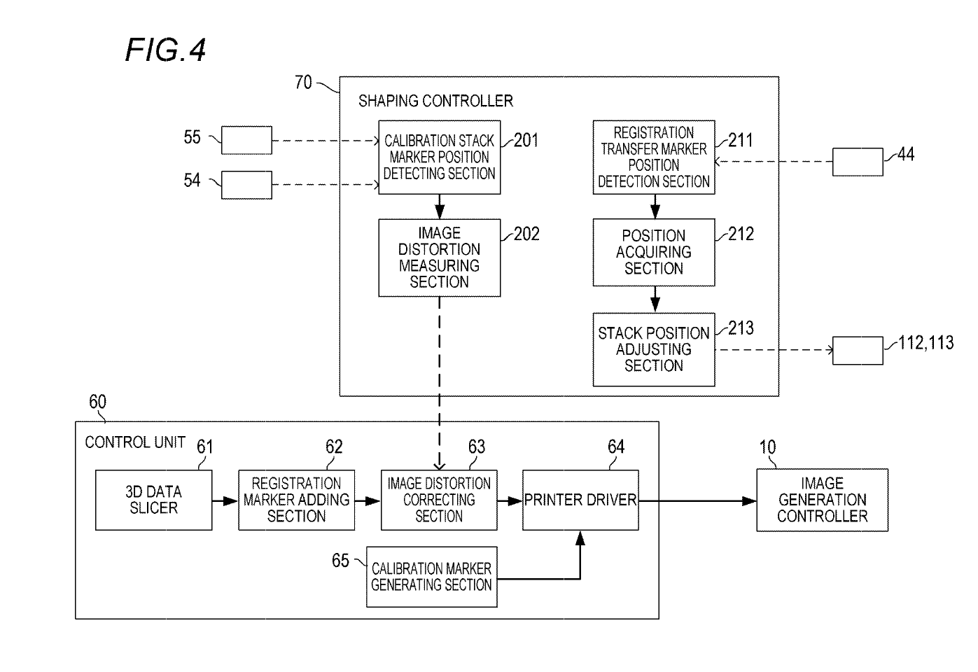

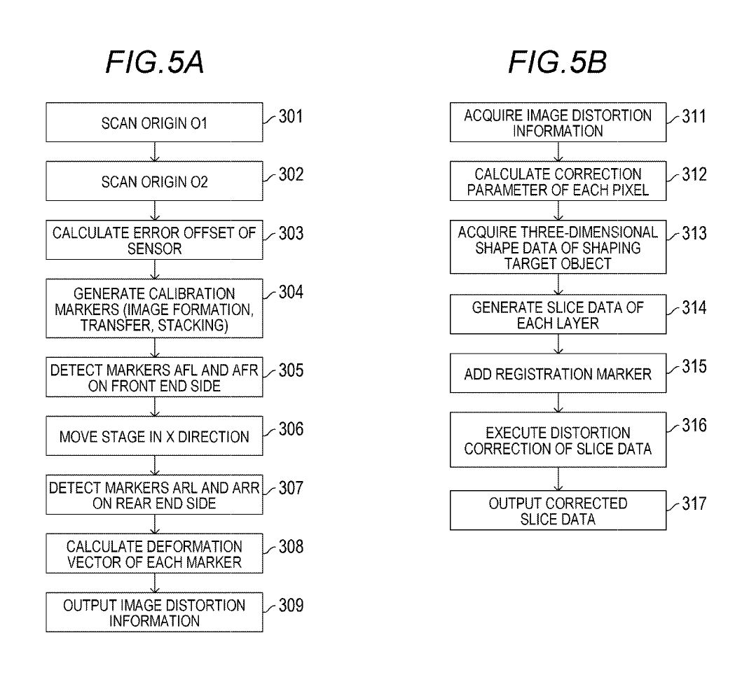

Details of offline calibration will be described with reference to FIGS. 4 and 5A. FIG. 4 is a block diagram showing functions related to offline calibration and FIG. 5A is a processing flow of offline calibration.

As shown in FIG. 4, the control unit 60 includes a calibration marker generating section 65 as a function related to offline calibration. In addition, the shaping controller 70 includes a calibration stack marker position detecting section (a marker detecting section) 201 and an image distortion measuring section 202 as functions related to offline calibration. The calibration stack marker position detecting section 201 is a function of detecting positions of the respective markers AFL, AFR, ARL, and ARR based on sensing results of the material left front end sensor 54 and the material right front end sensor 55. The image distortion measuring section 202 is a function of obtaining deformation vectors VFL, VFR, VRL, and VRR of the respective markers.

A flow of offline calibration by the shaping controller 70 will be described based on the flow chart shown in FIG. 5A.

In step 301, the shaping controller 70 monitors output of the material left front end sensor 54 while changing an XY position of the stage 52 by controlling the stage X-drive motor 112 and the stage Y-drive motor 113. Upon detecting the origin O1, the shaping controller 70 stores the XY position of the stage 52 at that point as X=0, Y=0. In step 302, the shaping controller 70 monitors output of the material right front end sensor 55 while changing the XY position of the stage 52 in a similar manner. In step 303, the shaping controller 70 stores a difference between an XY position of the stage 52 upon detection of the origin O2 and an XY position of the stage 52 upon detection of the origin O1 as X=dx, Y=dy. This (dx, dy) is an error offset amount representing attachment errors of the material left front end sensor 54 and the material right front end sensor 55. When the attachment errors of the two sensors 54 and 55 are negligible (in other words, when dx=dy=0 can be assumed), processes of steps 302 and 303 may be omitted.

In step 304, the calibration marker generating section 65 of the control unit 60 causes the material layer forming unit 100 and the shaping unit 200 to perform a process of generating a calibration stack marker by outputting calibration marker data to the image generation controller 10. Specifically, based on calibration marker data, the material layer forming unit 100 forms a calibration marker made of the shaping material on the photosensitive drum 34 in a same process as forming a material layer of a shaping object. The marker is transferred from the photosensitive drum 34 onto the transfer body 42 and conveyed to the shaping unit 200 as a calibration transfer marker. When a front end of a calibration transfer marker is detected by the material front end detection sensor 45, the shaping controller 70 controls the stage 52 so that the stage 52 enters a stack position at a same timing as the calibration transfer marker. Subsequently, the calibration transfer marker is transferred onto the stage 52 by the heater roller 43 and a calibration stack marker is obtained. As shown in FIG. 3B, the calibration stack markers AFL, AFR, ARL, and ARR include information on image distortion having occurred in processes from the material layer forming step to the shaping step or, more specifically, in a series of processes such as exposure, developing, transfer, and stacking.

In step 305, the shaping controller 70 monitors outputs of the material left front end sensor 54 and the material right front end sensor 55 while changing the XY position of the stage 52 by controlling the stage X-drive motor 112 and the stage Y-drive motor 113. The XY position of the marker AFL detected by the material left front end sensor 54 and the XY position of the marker AFR detected by the material right front end sensor 55 are stored in the calibration stack marker position detecting section 201. In step 306, the shaping controller 70 controls the stage X-drive motor 112 to move the stage 52 to positions of the rear end calibration stack markers ARL and ARR. In step 307, the shaping controller 70 monitors outputs of the material left front end sensor 54 and the material right front end sensor 55 while changing the XY position of the stage 52 by controlling the stage X-drive motor 112 and the stage Y-drive motor 113. The XY position of the marker ARL detected by the material left front end sensor 54 and the XY position of the marker ARR detected by the material right front end sensor 55 are stored in the calibration stack marker position detecting section 201.

In step 308, based on the XY position of the origin O1, the image distortion measuring section 202 calculates XY positions (referred to as normal positions) of the respective markers AFL, AFR, ARL, and ARR when there is no image distortion. In addition, based on the normal position of each marker and a difference from a detection position of each marker as detected in steps 305 and 307, the image distortion measuring section 202 calculates deformation vectors VFL, VFR, VRL, and VRR which represent an amount of displacement and a direction of displacement of the respective markers. When there is an error offset amount (dx, dy) between the two sensors 54 and 55, the error offset amount (dx, dy) is taken into consideration when calculating the deformation vectors VFR and VRR.

In step 309, the shaping controller 70 transmits the deformation vector of each marker to the control unit 60 as image distortion information related to image distortion that occurs on a material layer during a period from formation thereof by the material layer forming unit 100 to stacking on the stage.

(Image Distortion Correction)

Next, image distortion correction that is executed during formation of a material layer based on image distortion information acquired in advance by offline calibration will be described with reference to FIGS. 4 and 5B.

As shown in FIG. 4, the control unit 60 includes a 3D data slicer 61, a registration marker adding section 62, an image distortion correcting section 63, and a printer driver 64 as functions related to slice data generation and image distortion correction. Hereinafter, operations of the control unit 60 during formation of a material layer will be described based on the flow chart shown in FIG. 5B.

In step 311, image distortion information is acquired from the shaping controller 70. In step 312, the image distortion correcting section 63 calculates inverse vectors from the deformation vectors of markers at the four corners obtained as image distortion information and calculates a correction parameter for each pixel by linearly interpolating the inverse vectors. A correction parameter is information indicating, for example, correspondence between a pixel coordinate in an image prior to correction and a pixel coordinate in the image after the correction.

In step 313, data of a three-dimensional shape of a shaping target object is read. In step 314, based on three-dimensional shape data, the 3D data slicer 61 slices a three-dimensional shape of the shaping target object at a prescribed pitch (for example, at a thickness of several microns to slightly more than 10 microns) to generate a slice image of each layer. In step 315, the registration marker adding section 62 adds a registration marker to the slice image of each layer to generate slice data. Details of a registration marker will be provided later. As an alternative to steps 314 and 315, slice data of each layer may be generated by adding a stack body of registration markers to data of the three-dimensional shape read by the registration marker adding section 62 and then having the 3D data slicer 61 perform slicing.

In step 316, the image distortion correcting section 63 performs distortion correction of slice data using the correction parameter obtained in step 312. The distortion correction at this point is a process of imparting distortion in an opposite direction to a slice image so that image distortion that occurs during the processes from material layer formation to shaping is reduced or canceled. Moreover, besides performing distortion correction on data after slicing by the 3D data slicer 61, distortion correction of slice data can be performed by performing distortion correction on data of the three-dimensional shape prior to slicing. In step 317, the printer driver 64 transmits slice data after correction to the image generation controller 10.

As described above, by correcting sliced image data based on image distortion information obtained by offline calibration, a material layer with no or small image distortion when stacked on the stage 52 can be formed and dimensional accuracy of a shaping object can be improved.

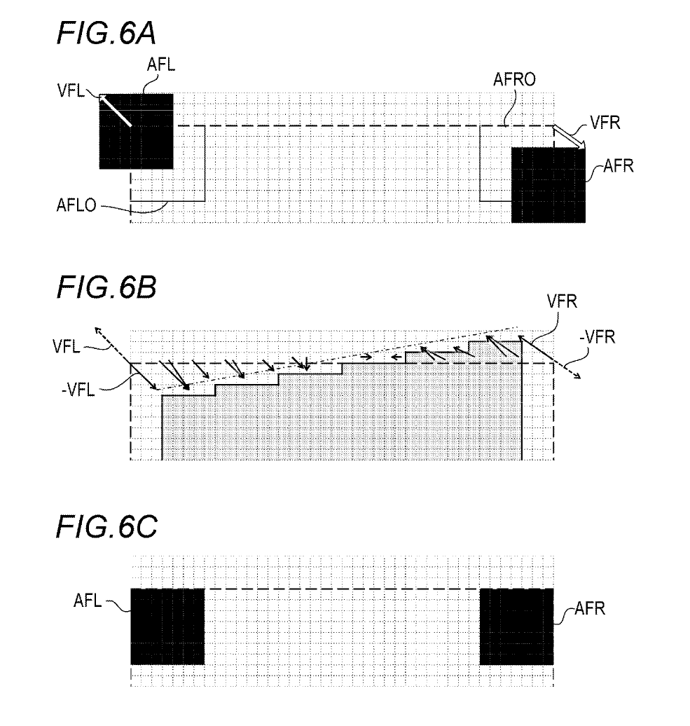

A concept of image distortion correction will be described with reference to FIGS. 6A to 6C. FIGS. 6A to 6C only show correction of pixels of an upper end side of an image for the sake of brevity (in actual correction, similar correction is performed on all pixels in the image).

A dashed line in FIG. 6A indicates a shaping area on the stage 52 and white squares AFLO and AFRO to the left and right of the shaping area indicate normal positions of calibration stack markers in a state where there is no image distortion. In addition, black squares AFL and AFR indicate positions where calibration stack markers are actually stacked during offline calibration. VFL and VFR respectively represent deformation vectors of the markers AFL and AFR. The example in FIG. 6A shows that an image has been extended leftward and rightward, a left side of the image has advanced from the normal position, and a right side of the image has retreated from the normal position.

FIG. 6B schematically shows a concept of image distortion correction. A dashed line indicates a shaping area on the stage 52 and a solid line virtually shows a area of a slice image after correction. At a top left edge of the image, a pixel is moved by an inverse vector −VFL of the deformation vector VFL. At a top right edge of the image, a pixel is moved by an inverse vector −VFR of the deformation vector VFR. At positions between the top left edge and the top right edge, pixels are moved and thinned by linear interpolation of the inverse vectors −VFL and −VFR. Moreover, since a slice image used in shaping is a binary image (presence or absence of material particles), each pixel cannot have an intermediate gradation. Therefore, correction of image distortion (movement of pixels) is performed in pixel units and an edge of the image after correction takes a stepped shape as shown in FIG. 6B. As for pixel thinning, simple thinning is performed in which, when two pixels have a same destination of movement as shown in FIG. 6B, any one of the pixels is deleted.

FIG. 60 shows an image formed on the stage 52 when material layer formation and shaping are performed using the slice data after correction indicated by the solid line in FIG. 6B. The calibration stack markers AFL and AFR are stacked at normal positions and front ends are uninclined straight lines. Accordingly, the stacking that image distortion is reduced can be realized. Although not strictly expressed herein, an upper end edge of the image has a stepped shape and pixels are partially inclined. The number of pixels is small and an actual box (one pixel) is slightly expanded such that a horizontal width equals a normal width. In the case of a particle when one pixel is 50 microns, an expansion or contraction of 1% equates to an expansion or contraction of 0.5 microns, which is not visually recognizable at an entire image level.

(Online Registration)

Next, online registration that is performed during stacking of a material layer will be described. In online registration, a registration marker is inserted to a material layer and positioning during stacking is performed based on a detection position of the marker.

In the following description, image data for a registration marker to be supplied to the image generation controller 10 will be referred to as “registration marker data”. In addition, a portion made of shaping material formed based on registration marker data of a material layer will be referred to as a “registration marker” or simply a “marker”. Furthermore, a marker transferred to the transfer body 42 from the photosensitive drum 34 (in other words, a marker on the transfer body 42) will be referred to as a “registration transfer marker” and a marker transferred onto the stage 52 will be referred to as a “registration stack marker”. The name of a marker is changed from one location to another because locations of the marker are favorably distinguished from one another for the same of brevity due to the fact that image distortion may change as the marker is transferred, the marker is detected using a different sensor at each location, and the like. Moreover, in a context where locations need not be particularly distinguished, the term “registration marker” or “marker” will be used.

As shown in FIG. 4, the shaping controller 70 includes a registration transfer marker position detecting section 211, a position acquiring section 212, and a stack position adjusting section 213 as functions related to online registration.

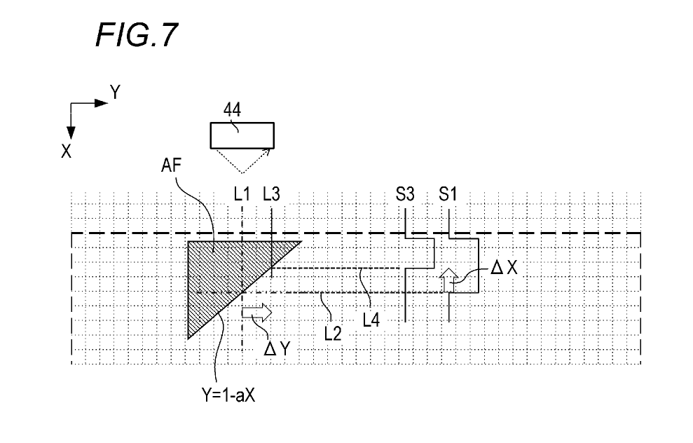

As described with reference to step 315 in FIG. 5B, a data of a registration marker for positioning is embedded in slice data of each layer. In the present embodiment, as shown in FIG. 7, a registration marker AF that is a right triangle is formed at a prescribed position (a position not overlapping with a section of a shaping object) in a shaping area.

The registration transfer marker position detecting section 211 detects the registration transfer marker AF on the transfer body 42 using the material front end detection sensor 44. Subsequently, the position acquiring section 212 acquires an X-direction position (a front end position) and an amount of deviation of a Y-direction position of the material layer based on a result of detection of the registration transfer marker AF. In this case, the X-direction refers to a direction of forward movement of the transfer body 42 and the Y-direction refers to a width direction (a direction perpendicular to the direction of forward movement) of the transfer body 42. Based on the X-direction position of the material layer, the stack position adjusting section 213 controls a drive start timing of the stage X-drive motor 112 and aligns a front end of the shaping object on the stage 52 with a front end of the material layer on the transfer body 42. In addition, based on the amount of deviation of the Y-direction position of the material layer, the stack position adjusting section 213 controls the stage Y-drive motor 113 and aligns a left end of the shaping object on the stage 52 with a left end of the material layer on the transfer body 42. Accordingly, a stacking variation in an XY plane between the shaping object and the material layer is eliminated online and high-quality shaping can be performed.

FIG. 7 is a conceptual diagram of detection of a registration transfer marker on a transfer body. The registration transfer marker AF is formed at a prescribed position (a position not overlapping with a section of a shaping object) in a front end portion of a shaping area on the transfer body 42. The registration transfer marker AF according to the present embodiment is a graphic with a shape of a right triangle having a first edge that is perpendicular to a direction of forward movement of the transfer body 42 (X direction) and a second edge that is oblique to the X direction.

An amount of variation of the hypotenuse of the right triangle is expressed by an equation as

Y=1−aX,

where a denotes an incline of the hypotenuse and a length of one side of the triangle is 1.

When a left end side of the registration transfer marker AF transferred without deviation is assumed to be Y=0 and a normal position is assumed to be Y=0.5, an amount of deviation ΔY can be expressed as

ΔY=Y−0.5=(1−aX)−0.5=0.5−aX.

When the incline of the hypotenuse is 45°, a=1, and
ΔY=0 when X=0.5,
ΔY=0.5 when X=0, and
ΔY=−0.5 when X=1, where 0<X<1.

The first edge and the second edge of the registration transfer marker AF are detected by the material front end detection sensor 44. L1 denotes a detection line of the material front end detection sensor 44 when the registration transfer marker AF on the transfer body 42 passes the normal position. In other words, a state where the material front end detection sensor 44 passes the line L1 constitutes a reference (amount of deviation ΔY=0). S1 denotes an output signal of the material front end detection sensor 44 when passing the line L1. When the first edge of the registration transfer marker AF is detected, the signal changes from a low level to a high level. When a second edge L2 is detected, the signal changes from a high level to a low level.

Supposing that the transfer body 42 shifts to the left by ΔY from the reference, the material front end detection sensor 44 passes a line L3. S3 denotes an output signal of the material front end detection sensor 44 when passing the line L3. When the first edge of the registration transfer marker AF is detected, the signal changes from a low level to a high level. When a second edge L4 is detected, the signal changes from a high level to a low level.

Therefore, an X-direction position (a front end position) can be obtained based on a timing of rising of the output signal S3 of the material front end detection sensor 44. In addition, the amount of deviation ΔY of the Y-direction position of the registration transfer marker with respect to the normal position can be obtained from a high-level period of the output signal S3 (a difference between a detection timing of the first edge and a detection timing of the second edge) and the equation Y=1−aX. As described above, positions in the two directions X and Y can be detected with one registration transfer marker and one material front end detection sensor 44. This offers a cost advantage as a result of simplified configurations and processes as well as an advantage that positioning in two directions can be performed at high speed. Since the transfer body 42 and the stage 52 move at high speed during stacking, a configuration such as that of the present embodiment is effective. However, when the deviation of the Y-direction position is small enough to be negligible, the X-direction position need only be detected and, for example, a quadrangular marker having two sides parallel to the Y direction and two sides parallel to the X direction can be used.

According to the configuration described above, by performing offline calibration and image distortion correction, a distortion in an XY plane of an image which occurs during processes from material layer formation to shaping can be minimized. In addition, by performing online registration, a deviation of a position during stacking can be minimized. Therefore, a high-quality shaping object with high shape accuracy and high dimensional accuracy can be formed.

Image distortion attributable to formation of a material layer occurs due to, for example, distortion of the photosensitive drum 34, distortion of the developing roller 32, a deviation in alignment of each roller shaft, abrasion of each member, and the like. Therefore, the offline calibration is favorably executed when the cartridge 30 is replaced or when a period of use of the cartridge 30 reaches a prescribed value, and the like.

While a case where one process cartridge is provided has been described heretofore for the sake of brevity, in the present embodiment, a plurality of process cartridges are provided. Such a configuration can be used for the purpose of, for example, readily forming a shaping object having a support body made of a material that differs from that of the shaping object main body (for example, a material with high removability) by injecting a support material into one of the plurality of cartridges. In this case, data related to information on the support material is added to slice data of the shaping target object and the control section generates slice data for shaping.

In this case, by providing a plurality of cartridges other than the cartridge in which a support material is to be stored, various build materials can be stored in the plurality of cartridges. For example, the configuration can be used for the purpose of injecting a same material into two of the plurality of cartridges, forming a material layer using one cartridge, and when the material is used up, automatically switching to the other cartridge to continue material layer formation. Alternatively, the plurality of cartridges may be filled with materials having different colors or physical properties and used to create a multicolored shaping object or to create a shaping object by stacking material layers containing a mixture of a plurality of materials.

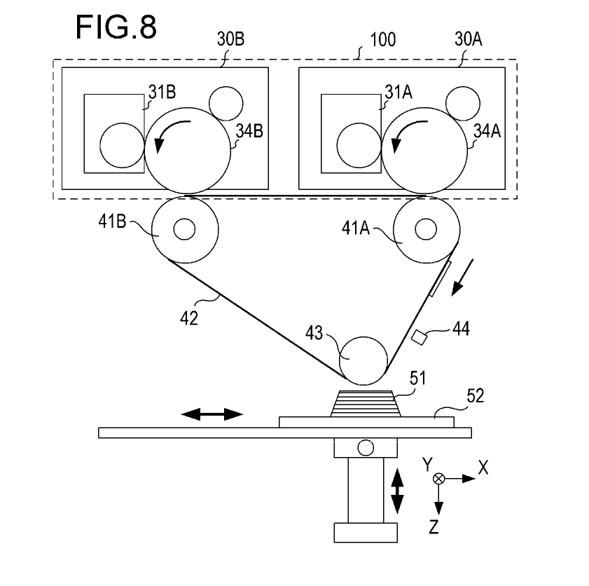

FIG. 8 is a diagram showing a configuration of a shaping system including two cartridges. In the example shown in FIG. 8, the material layer forming unit 100 is provided with a first cartridge 30A including a photosensitive drum 34A and a transfer roller 41A and a second cartridge 30B including a photosensitive drum 34B and a transfer roller 41B. A shaping material is sequentially transferred from the transfer rollers 41A and 41B to the same transfer body 42 to form a material layer in which two shaping materials are mixed. In this case, a build material A is stored in the cartridge 30A and a support material B is stored in the cartridge 30B in respective shaping material supplying sections 31A and 31B thereof.

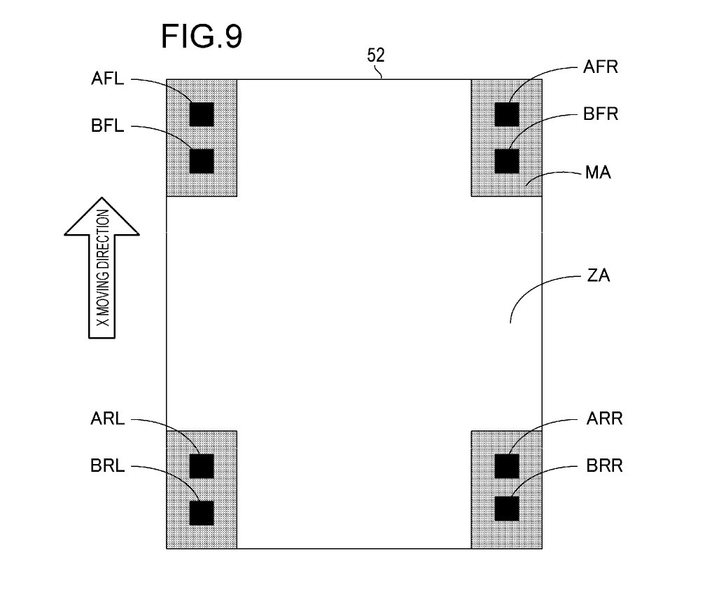

An overview and usage of a shaping area ZA will now be described with reference to FIG. 9. As described earlier, calibration markers with square shapes are approximately arranged at four corners of the shaping area ZA on the stage 52.

In the case of the shaping system shown in FIG. 8 which includes the build material A and the support material B as shaping materials, a marker such as that shown in FIG. 9 is used as a calibration marker. Specifically, front left end calibration markers AFL and BFL, front right end calibration markers AFR and BFR, rear left end calibration markers ARL and BRL, and rear right end calibration markers ARR and BRR are approximately arranged at four corners of the shaping area ZA.

The markers AFL, AFR, ARL, and ARR are calibration markers related to stacking of the build material A and the markers BFL, BFR, BRL, and BRR are calibration markers related to stacking of the support material B. As shown in FIG. 9, the groups of calibration markers and a vicinity thereof are assumed to be a calibration marker area MA.

Basically, a cross-shaped area excluding the calibration marker area MA shown in FIG. 9 can be liberally used as an arbitrary shaping area ZA in any layer in accordance with a shape of a desired shaping object.

However, a calibration marker is to be formed by being stacked only once on the stage 52 before, for example, starting stacking material layers in accordance with slice data. Focusing on this fact, a feature of the present embodiment is that, by performing a stacking operation to be described later, an entire shaping area ZA including the calibration marker area MA is used as an arbitrary shaping area ZA when stacking third and subsequent layers (depending on a shape of a desired shaping object, second and subsequent layers).

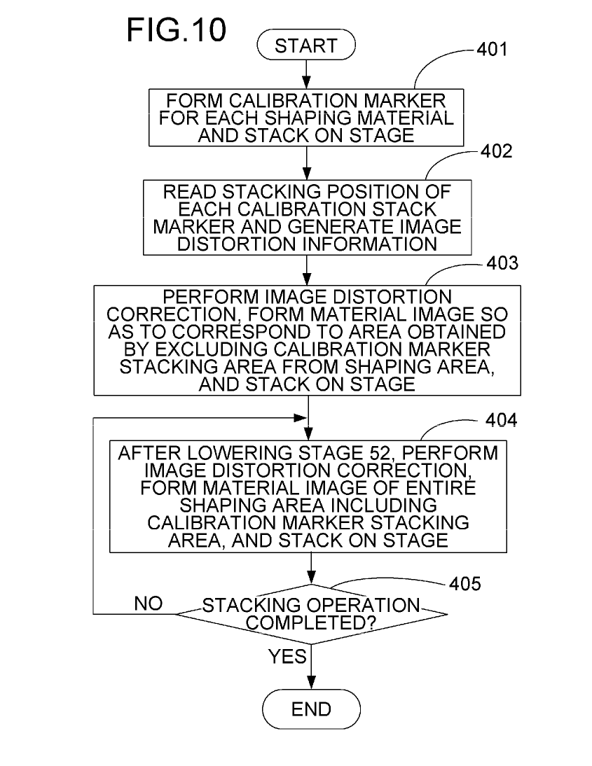

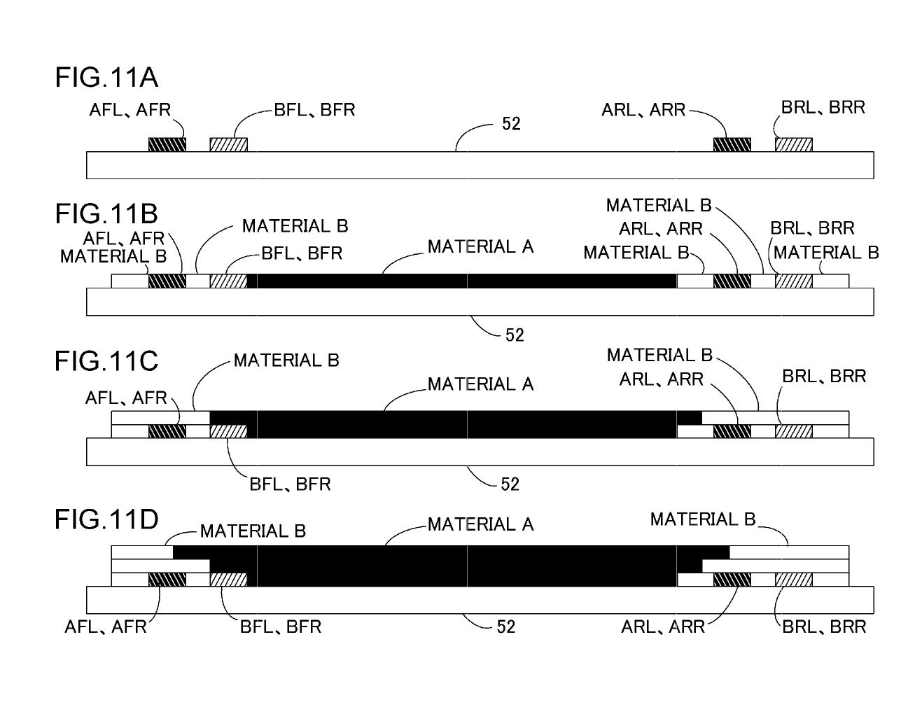

Next, a stacking operation by a shaping system according to the present embodiment will be described in detail. FIG. 10 is a flow chart showing a procedure of a stacking operation and FIGS. 11A to 11D are schematic sectional views showing a shaping process on the stage 52 by vertical sections passing through the calibration markers AFL, BFL, ARL, and BRL (or AFR, BFR, ARR, and BRR). Hereinafter, a stacking operation by the shaping system will be described along the flow chart shown in FIG. 10.

First, in step 401, a calibration marker is formed for each shaping material and a first stacking is performed on an upper end surface on the stage 52. A vertical section of the shaping object at this point is shown in FIG. 11A.

Next, in step 402, a stacking position of each calibration stack marker on the stage 52 is read and image distortion information is generated based on a difference from a normal position.

Subsequently, in step 403, distortion correction is performed on slice data based on the image distortion information, a material layer which includes an image in accordance with the slice data and which corresponds to a area obtained by excluding a stacking area (an arrangement area) of the calibration stack marker from the shaping area is formed, and a second stacking is performed on the upper end surface on the stage 52.

By forming a material layer so as to correspond to an area obtained by excluding a stacking area of a calibration stack marker from the shaping area on the stage 52, a material layer created as though by punching out a portion of a calibration marker is obtained. This material layer is stacked on the stage 52 so as to be fitted into the calibration stack marker already stacked in step 401. In this manner, stacking of a layer including a calibration marker on the stage 52 (a first layer formed on the stage 52) is completed by two stacking operations. In this case, a layer including a calibration marker on the stage 52 corresponds to a first layer when a stacking operation is performed on the stage 52 immediately after stacking a calibration marker.

A vertical section of the stack structure at this point is shown in FIG. 11B. In the diagram, in the stack structure on the stage 52, a black area indicates a portion constituted by the build material A and a white area indicates a portion constituted by the support material B. As is apparent from the diagram, a flat surface is formed in the entire shaping area ZA after step 403 is executed. In addition, as shown in FIG. 11B, the support material B is stacked in areas adjacent to calibration markers ARL and ARR formed by the build material A. Accordingly, the calibration markers can be easily separated from a main body of the shaping object after the stacking operation is completed.

In step 403, a material layer is formed so as to correspond to a area obtained by excluding a stacking area of a calibration stack marker from the shaping area on the stage 52. At this point, a desired material layer with a punched-out shape may not always be obtained when image distortion correction is also performed on a stacking position of an original calibration stack marker (a calibration marker not subjected to image distortion correction). Therefore, in step 403, image distortion correction is not performed on a stacking position of a calibration stack marker. This can be realized by performing image distortion correction on image data not including a calibration marker and subsequently erasing a area corresponding to a stacking position of an original calibration stack marker from the corrected image data.

Next, in step 404, image distortion correction is performed based on the image distortion information, a material layer of the entire shaping area ZA including the stacking position of the calibration stack marker is formed, and the stage 52 is lowered by a thickness of one layer to stack the material layer on the upper end surface on the stage 52. A vertical section of the stack structure at this point is shown in FIG. 11C.

Since a calibration marker is not present in the material layer at this point to begin with, image distortion correction is performed over the entire area. In addition, unlike in step 403, stacking of a layer in which a calibration marker is not present in step 404 is completed by one stacking operation. Furthermore, as shown in FIG. 11C, the support material B is stacked on upper surfaces of the calibration markers ARL and ARR formed by the build material A in areas that are in contact with these markers. Accordingly, the calibration markers can be easily separated from the main body of the shaping object after the stacking operation is completed.

Hereinafter, step 404 is repetitively executed until the desired shaping object is obtained (step 405). In this case, by repetitively executing step 404 so that the stack structure shown in FIG. 11D is obtained by stacking the material layer once on the shaping object shown in FIG. 11C, the material layer is stacked on the shaping object on the stage 52. As is also apparent from FIGS. 11C and 11D, the build material A that constitutes the desired shaping object and the support material B are also stacked on an upper side of the calibration marker formed on the stage 52.

As described above, according to the present embodiment, an entire shaping area ZA including the calibration marker area MA can be made flat for third and subsequent layers or, depending on a shape of a desired shaping object, for second and subsequent layers. Therefore, quality and accuracy of a shaping object can be improved while effectively utilizing the entire shaping area ZA including the calibration marker area MA on the stage 52 without having to remove a calibration marker.

While a shaping object is formed in the present embodiment by stacking a layer including the build material A for a first layer as shown in FIGS. 11B to 11D, this method is not restrictive. When the entire shaping area ZA including the calibration marker area MA is desirably used as the shaping area ZA even when stacking a lowermost layer of a shaping object, for example, the support material B may be used as the shaping material to be stacked in the entire shaping area ZA in a stacking operation of a second layer on the stage. In other words, a calibration marker is stacked on the stage (a first stacking operation) and, subsequently, a material layer made of support material is stacked in a shaping area excluding a stacking area of the calibration stack marker (a second stacking operation) to form a first layer on the stage. Next, a material layer made of the support material B is stacked in the entire shaping area ZA (a third stacking operation) to form a second layer on the stage. Accordingly, the entire shaping area ZA including the calibration marker area MA can be used as the shaping area ZA from the third layer on the stage. In this manner, with respect to a calibration marker formed by the build material A, the calibration marker can be prevented from sticking to a build body by using the support material B to form a material layer to be stacked in a area that comes into contact with the marker. Accordingly, the calibration marker can be easily separated from the build body after the stacking operation is completed.

A case where a calibration marker is formed by performing stacking once has been described with reference to FIG. 11. However, depending on detection means or a material constituting a calibration marker, there are cases where a marker cannot be recognized unless the marker is formed by a plurality of layers such as when a position of the calibration marker is detected using reflection of light. In such a case, a method is favorably used in which a calibration marker is stacked on the stage and, subsequently, a material layer made of support material is stacked in a shaping area excluding a stacking area of the calibration stack marker. For example, let us assume that a calibration marker is to be formed by N-number of layers. In this case, a stacking operation for stacking a calibration marker and a stacking operation for stacking a material layer made of support material in a shaping area excluding a stacking area of the calibration stack marker may be alternately repeated up to a (2N−1)-th stacking operation. As a result, stacking can be performed in a similar manner to FIG. 11B for 2N-th and subsequent stacking operations.

In addition, while the present embodiment adopts an operation flow in which a stacking operation is performed by unfailingly forming any of the shaping materials in the entire shaping area ZA for each layer, this operation flow is not restrictive and a area where none of the shaping materials is formed may exist in accordance with a shape of a desired shaping object.

Furthermore, when increasing the number of types of shaping materials for the purpose of adding color using a coloring material or the like, the number of calibration markers may be increased as appropriate in accordance with the number of shaping materials.

Moreover, although a registration marker is to be also stacked on an upper end surface of the stage 52 for each layer as a registration stack marker, since the registration stack marker and a desired shaping object do not come into contact with each other in any layer, the shape of the shaping object is not disturbed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-131763, filed on Jun. 30, 2015, which is hereby incorporated by reference herein in its entirety.

What is claimed is:

1. A shaping system of a three-dimensional object, comprising:
a material layer forming unit which arranges a shaping material based on supplied data to form a material layer;
a shaping unit which stacks the material layer on a shaping area of a stage; and
a control unit which controls the material layer forming unit and the shaping unit, wherein
the control unit performs an operation of supplying data of a calibration marker to the material layer forming unit and stacking a material layer formed based on the data of the calibration marker on the stage, and an operation of supplying, to the material layer forming unit, data for arranging the shaping material in an entire area of the shaping area excluding an arrangement area of the calibration marker after the material layer formed based on the data of the calibration marker and stacking, on the stage, a material layer formed based on the data for arranging the shaping material in the entire area of the shaping area excluding the arrangement area of the calibration marker.

2. The shaping system according to claim 1, wherein the control unit stacks a material layer having a area in which the shaping material is arranged based on slice data generated from three-dimensional shape data of a shaping target object on a area including the arrangement area of the calibration marker on the stage,
after the operation of stacking, on the stage, the material layer formed based on data for arranging the shaping material in the entire area of the shaping area excluding the arrangement area of the calibration marker.

3. The shaping system according to claim 1, wherein
when the shaping material includes a build material which constitutes a shaping object and a support material which constitutes a support body that supports the shaping object during shaping and when the calibration marker is formed by the build material, the control unit forms a area that is in contact with the calibration marker on the stage with the support material.

4. The shaping system according to claim 3, wherein
the control unit forms, with the support material, a material layer for arranging the shaping material in the entire area of the shaping area excluding an arrangement area of the calibration marker.

5. The shaping system according to claim 3, wherein
the control unit stacks a material layer made of the support material in the entire shaping area after the operation of stacking, on the stage, the material layer for arranging the shaping material in the entire area of the shaping area excluding the arrangement area of the calibration marker.

6. The shaping system according to claim 1, further comprising:
a marker detecting section which detects the calibration marker stacked on the stage;
an image distortion measuring section which measures image distortion of the calibration marker stacked on the stage based on a detection result of the marker detecting section; and
a correcting section which performs, based on the image distortion measured by the image distortion measuring section, correction for reducing the image distortion on slice data generated from three-dimensional shape data of a shaping target object supplied to the material layer forming unit, wherein
the image distortion measuring section obtains image distortion of the calibration marker stacked on the stage based on a difference between a detected position of the calibration marker by the marker detecting section and a normal position that is a position where the calibration marker is to be stacked in a case where there is no image distortion.

7. The shaping system according to claim 6, wherein
the calibration marker includes a plurality of markers arranged separated from each other in a shaping area on the stage.

8. The shaping system according to claim 6, wherein
the calibration marker includes a plurality of markers arranged at four corners in a rectangular shaping area on the stage.

9. The shaping system according to claim 7, wherein
the image distortion measuring section obtains image distortion at a position other than the plurality of markers in the shaping area by linear interpolation of image distortion of the plurality of markers.

10. The shaping system according to claim 1, wherein
the material layer forming unit forms the material layer by an electrophotographic process.

11. A shaping method of fabricating a three-dimensional object by sequentially stacking a material layer, in which a shaping material is arranged based on data, in a shaping area of a stage, the shaping method comprising the steps of:
forming a material layer based on data of a calibration marker and stacking the material layer in the shaping area; and
arranging the shaping material in the entire shaping area excluding a area in which the material layer formed based on the data of the calibration marker is arranged.

12. The shaping method according to claim 11, further comprising
a step of stacking a material layer having a area in which the shaping material is arranged based on slice data generated from three-dimensional shape data of a shaping target object on a area in which the material layer formed based on the data of the calibration marker is arranged on the stage,
after the step of arranging the shaping material in the entire shaping area excluding the area in which the material layer formed based on the data of the calibration marker is arranged.

13. The shaping method according to claim 11, wherein
a build material which constitutes a shaping object and a support material which constitutes a support body that supports the shaping object during shaping are used as the shaping material, and the shaping method further comprises
a step of stacking a material layer made of the support material in the entire shaping area, after the step of arranging the shaping material in the entire shaping area excluding the area in which the material layer formed based on the data of the calibration marker is arranged.

14. The shaping method according to claim 12, further comprising the steps of:
detecting a position of the calibration marker stacked in the shaping area on the stage;
measuring image distortion of the calibration marker stacked on the stage based on a detection result of the position of the calibration marker; and
performing correction for reducing the image distortion on the slice data based on the image distortion.

15. The shaping method according to claim 14, wherein
in the step of measuring the image distortion of the calibration marker stacked on the stage, the image distortion of the calibration marker stacked on the stage is obtained based on a difference between a detected position of the calibration marker and a normal position that is a position where the calibration marker is to be stacked in a case where there is no image distortion.
